(19) United States
(12) Patent Application Publication
(10) Pub. No.: US 2005/0195358 A1
(43) Pub. Date: Sep. 8, 2005

(54) Multipurpose spectacle case

(75) Inventor: Sik Lung Lam, Hong Kong (HK)

Correspondence Address: FAEGRE & BENSON LLP;PATENT DOCKETING, 2200 WELLS FARGO CENTER, MINNEAPOLIS, MN, 55402, US

(73) Assignee: OKIA Optical Co., Ltd., Kowloon (HK)

(21) Appl. No.: 11/072,101

(22) Filed: Mar. 4, 2005

Related U.S. Application Data
(63) Continuation-in-part of application No. 10/794,684, filed on Mar. 5, 2004.

(51) Int. Cl. G02C 9/00

(52) U.S. Cl. 351/47

(57) ABSTRACT

A spectacle case including a housing assembly, a spectacle compartment, and at least one accessory compartment assembly. The housing assembly defines a housing space for storing a pair of spectacles therein. The housing space comprises a spectacle space and a remaining dead space. The spectacle compartment occupies the spectacle space defining an area that is reserved for occupation of the spectacle when the spectacle is received within the housing assembly. The at least one accessory compartment assembly occupies at least a portion of the dead space. The accessory compartment assembly includes at least one accessory compartment separation element for providing a desired separation of the spectacle compartment and the accessory compartment assembly.

### CROSS REFERENCE TO RELATED APPLICATION

This application is a Continuation-in-Part of U.S. patent application, Ser. No. 10/794,684, filed Mar. 5, 2004 and entitled “Multipurpose Spectacle Case.”

### BACKGROUND OF THE INVENTION

1. Field of the Invention

The present invention relates to a spectacle (i.e., eyeglass) case and more particularly to an eyeglass case having one or more internal compartments for storing accessory items.

2. Description of the Related Art

A variety of types of cases for containing spectacles are known. Of these, certain dual-function eyeglass cases existing in the art may have some tangential general relevance to the present invention. Of interest are U.S. Pat. No. 683,417 to Weinstein, U.S. Pat. No. 1,004,474 to Schnorr, U.S. Pat. No. 1,649,255 to Robinson, and U.S. Pat. No. 3,000,417 to Goldstein, each of which teaches a case for containing two pairs of eyeglasses. Similarly, of general interest is U.S. Pat. No. 3,323,638 to Dishart which teaches an eyeglass case for containing a pair of spectacles, a nail file, a comb, a nail clipper, and a magnifying glass.

U.S. Pat. No. 6,003,663 to Newcomber discloses an eyeglass case generally comprising a substantially rigid internal shell member surrounded by a flexible covering material provided with a closure flap selectively securable in a closed position for retaining eyeglasses in protective storage within the inner shell member. The shell member includes an inverted V-shaped support member extending upwardly from a floor of the shell member which engages a nose recess of a pair of eyeglasses stored within the case. In accordance with embodiments of the invention, the shell member includes one or more internal receptacles for storage of miscellaneous accessory items such as nose pads, spare screws, a small screwdriver, lens cleaning solution, a lens wiping cloth, etc.

U.S. Pat. No. 5,016,749 to Kaye et al discloses an eyeglass and contact lens holder that includes a carrying case for simultaneously carrying spectacles and contact lenses. The case has a hollow open base for containing the spectacles and further contains a contact lens case secured to an interior surface of the base where contact lenses may be stored. A lid is hingedly connected to the base for covering the open portion thereof.

It is an object of the present invention to provide an improved eyeglass case.

### SUMMARY OF THE INVENTION

In a broad aspect, the present invention is a spectacle case including a housing assembly, a spectacle compartment, and at least one accessory compartment assembly. The housing assembly defines a housing space for storing a pair of spectacles therein. The housing space comprises a spectacle space and a remaining dead space. The spectacle compartment occupies the spectacle space defining an area that is reserved for occupation of the spectacle when the spectacle is received within the housing assembly. The at least one accessory compartment assembly occupies at least a portion of the dead space. The accessory compartment assembly includes at least one accessory compartment separation element for providing a desired separation of the spectacle compartment and the accessory compartment assembly.

Various shapes and types of spectacle compartment and accessory compartment assemblies are disclosed. For example, the accessory compartment assemblies may include any single existing/future electrical/electronic device or combined existing/future electrical/electronic devices, including but not limited to thermometer, radio, calculator, clock, MP3 player, digital music player, digital camera, personal digital assistant (PDA), global position system (GPS), 3G end point, digital voice recorder, mobile phone, pocket PC, digital map display, alarm, electronic dictionary, game player, walkie talkie, laser pen, pedometer, portable media player, television receiver, luminated devices, electrical shaver, portable scanner, electronic data storage device, digital video recorder, etc.

In the preferred embodiment, the housing space defines a dimension that minimally fits a pre-determined eyewear such that the housing space is only large enough to accommodate the eyewear as well as the dead space that is created by the irregular shape of a spectacle. As such, the eyewear case according to the present invention does not need to be larger than a standard eyewear case that a pair of spectacle can barely fit into, yet contains additional compartment(s) and/or function(s) not found in a prior art case of the same dimensions.

In another aspect of the present invention, a multi-purpose eyeglass case is provided with a radio assembly disposed within the housing of the case.

In another aspect of the present invention, a multi-purpose eyeglass case is provided with a digital music player assembly disposed within the housing of the case.

In another aspect of the present invention, a multi-purpose eyeglass case is provided with any single or combined thermometer, conventional clock, or existing/future electrical/electronic devices, including but not limited to, radio, calculator, clock, MP3 player, digital music player, digital camera, personal digital assistant (PDA), global position system (GPS), 3G end point, digital voice recorder, mobile phone, pocket PC, digital map display, alarm, electronic dictionary, game player, walkie talkie, laser pen, pedometer, portable media player, television receiver, luminated devices, electrical shaver, portable scanner, electronic data storage device, digital video recorder, etc.

Use of the present invention has several advantages over prior art devices, such as space savings, convenience, and multi-functionality.

### BRIEF DESCRIPTION OF THE DRAWINGS

FIG. 1A is a front, left perspective view of an embodiment of the present invention illustrating the use of the accessory compartment assemblies for a clock and a thermometer.

FIG. 1B is a top, left perspective view of an upper portion of the FIG. 1A embodiment with the lid open to reveal the accessory compartment assembly.

FIG. 1C is an end view of the lid of the FIG. 1A embodiment.

FIG. 1D is a side view of an upper portion of the FIG. 1A embodiment.

FIG. 1E is a section of FIG. 1A showing a hidden integrated circuit board position.

FIG. 1F is a front, left perspective view of another embodiment of the present invention illustrating the use of the accessory compartment assemblies for a digital music player and a thermometer.

FIG. 1G is a top, left perspective view of an upper portion of the FIG. 1F embodiment with the lid open to reveal the accessory compartment assembly.

FIG. 1H is a front, left perspective view of another embodiment of the present invention illustrating the use of the accessory compartment assemblies for a digital camera.

FIG. 1I is a top, left perspective view of an upper portion of the FIG. 1H embodiment with the lid open to reveal the accessory compartment assembly.

FIG. 2A is a front, left perspective view of another embodiment showing utilization of a clamshell assembly with a radio, with the spectacle case in a closed position.

FIG. 2B is a front, left perspective view of the FIG. 2A embodiment in an open position.

FIG. 2C is a section of FIG. 2A showing a hidden integrated circuit board position.

FIG. 2D is a front, left perspective view of another embodiment showing utilization of a clamshell assembly with a digital music player, with the spectacle case in a closed position.

FIG. 2E is a front, left perspective view of the FIG. 2D embodiment in an open position.

FIG. 3A is a perspective view of another embodiment showing utilization of a clamshell assembly with a radio and arcuately spaced accessory compartments, with the spectacle case being in a closed position.

FIG. 3B is a perspective view of the FIG. 3A embodiment in an open position.

FIG. 3C is a perspective view of another embodiment showing utilization of a clamshell assembly with a digital music player and arcuately spaced accessory compartments, with the spectacle case being in a closed position.

FIG. 3D is a perspective view of the FIG. 3C embodiment in an open position.

FIG. 4A is a perspective view of another embodiment showing utilization of a clamshell assembly with a radio attached to the cover, with the spectacle case being shown in a closed position.

FIG. 4B is a perspective view of the FIG. 4A embodiment in an open position.

FIG. 5A is a perspective view of another embodiment showing utilization of a clamshell assembly with a radio attached to an arching upper clamshell section, with the spectacle case being shown in a closed position.

FIG. 5B is a perspective view of the FIG. 5A embodiment in an open position.

FIG. 5C is a section of FIG. 5A showing a hidden integrated circuit board position.

FIG. 5D is a perspective view of another embodiment showing utilization of a clamshell assembly with a personal digital assistant attached to an arching upper clamshell section, with the spectacle case being shown in a closed position.

FIG. 5E is a perspective view of the FIG. 5D embodiment in an open position.

FIG. 6A is a perspective view of another embodiment showing utilization of a clamshell assembly with a calculator assembly, with the spectacle case being shown in a closed position.

FIG. 6B is a perspective view of the FIG. 6A embodiment in an open position.

FIG. 6C is a bottom perspective view of an end portion of the FIG. 6A embodiment in an open position.

FIG. 6D is a section of FIG. 6A showing a hidden integrated circuit board position.

FIG. 6E is a perspective view of another embodiment showing utilization of a clamshell assembly with a personal digital assistant assembly, with the spectacle case being shown in a closed position.

FIG. 6F is a perspective view of the FIG. 6E embodiment in an open position.

FIG. 6G is a bottom perspective view of an end portion of the FIG. 6E embodiment in an open position.

FIG. 7A is a perspective view of another embodiment showing utilization of a clamshell assembly having an oval cross-sectional area, with the spectacle case being shown in a closed position.

FIG. 7B is a perspective view of the FIG. 7A embodiment in an open position.

FIG. 7C is a section of FIG. 7B showing a hidden integrated circuit board position.

FIG. 7D is a section of FIG. 7B showing how an accessory compartment on the lid is opened.

FIG. 7E is a section of FIG. 7B showing how an accessory compartment located in the side of the case base is opened.

FIG. 8A is a perspective view of another embodiment showing utilization of a clamshell assembly having a radio and a plurality of arcuately spaced accessory compartments located about an internal surface of lower sidewalls of an arc-shaped base.

FIG. 8B is a perspective view of the FIG. 8A embodiment in an open position.

FIG. 9A is a perspective view of another embodiment showing utilization of a clamshell assembly with a detachable Radio assembly.

FIG. 9B is a perspective view of the FIG. 8A embodiment with the detachable Radio assembly shown detached therefrom.

FIG. 9C is a top perspective view of the detachable radio assembly of the FIG. 9A embodiment.

FIG. 9D is a bottom perspective view of the detachable radio assembly of the FIG. 9A embodiment, revealing the bracket for attachment.

FIG. 9E is a side view of the detachable radio assembly of the FIG. 9D embodiment.

FIG. 9F is a perspective view of the FIG. 9A embodiment in an open position, with the detachable radio assembly shown removed.

### DETAILED DESCRIPTION OF THE INVENTION

As used in the present patent application, the term “spectacle space” refers a space or an area in a spectacle case, which is reserved for occupation of the body of a spectacle when the spectacle is received within the housing assembly of the case. As used in the present patent application, the term “dead space” refers to a space or an area in the spectacle case, which is not reserved for occupation of the body of the spectacle when the spectacle is received within the housing assembly of the case. As used in the present patent application, the term “electrical/electronic device assembly” refers to a single existing/future electrical/electronic device or combined existing/future electrical/electronic devices, including but not limited to radio, calculator, clock, MP3 player, digital music player, digital camera, personal digital assistant (PDA), global position system (GPS), 3G end point, digital voice recorder, mobile phone, pocket PC, digital map display, alarm, electronic dictionary, game player, walkie talkie, laser pen, pedometer, portable media player, television receiver, luminated devices, electrical shaver, portable scanner, electronic data storage device, digital video recorder, etc.

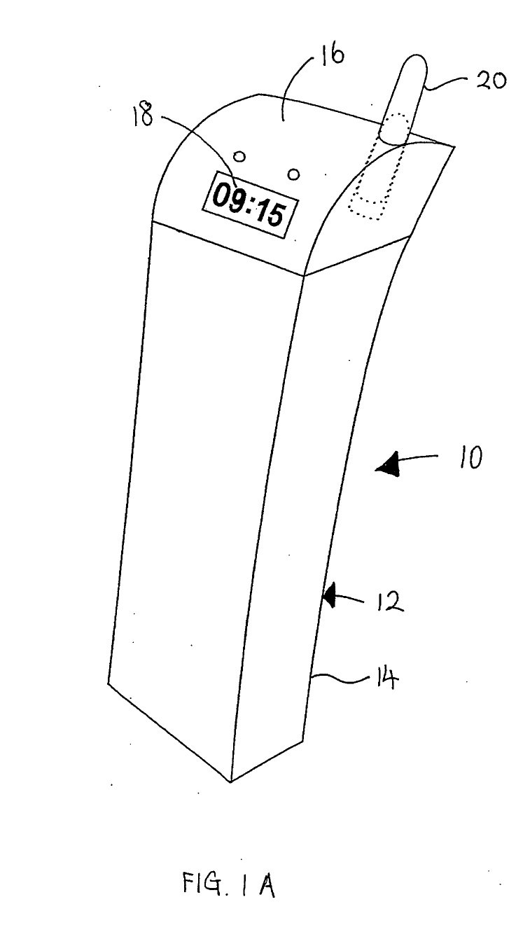

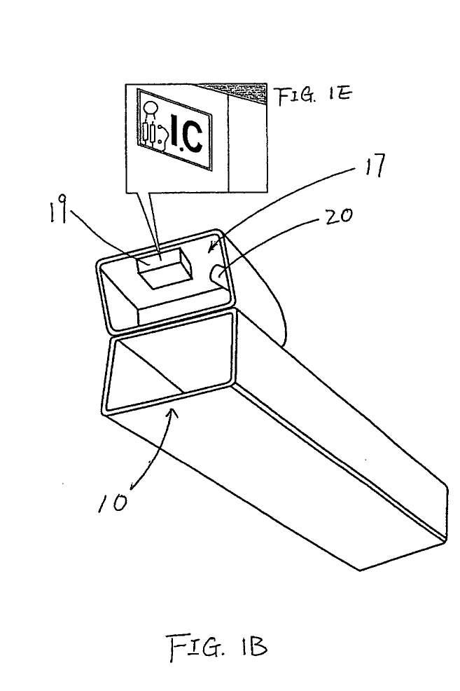

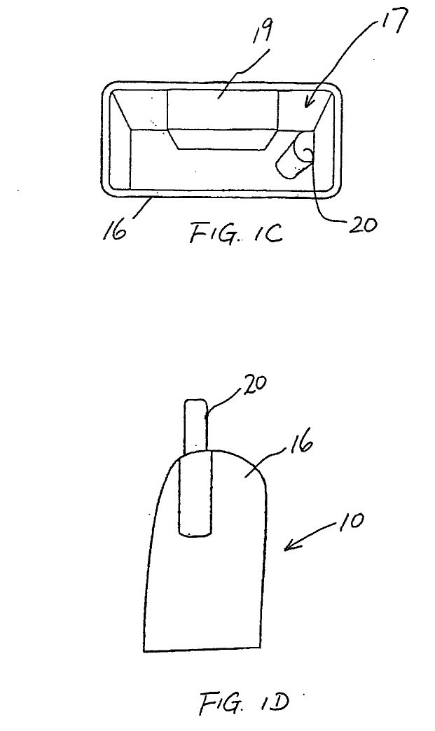

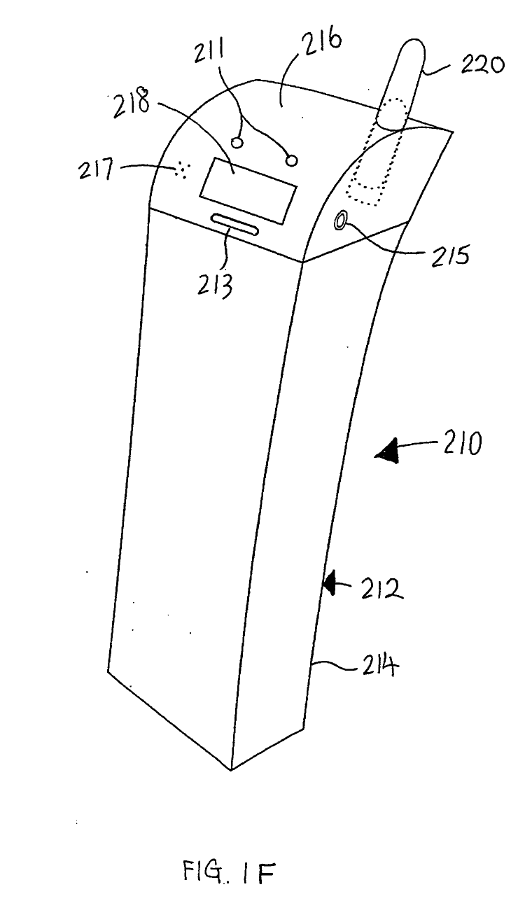

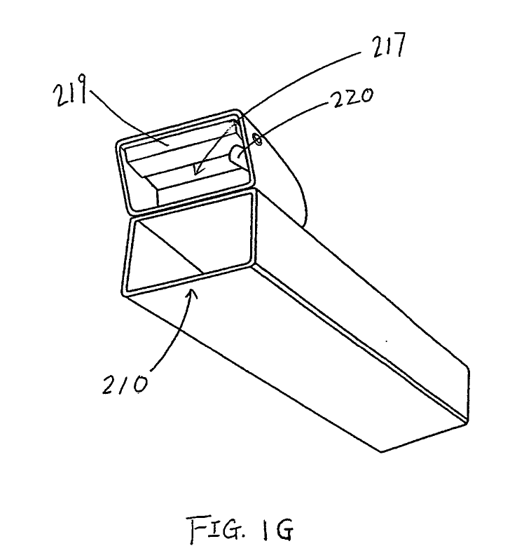

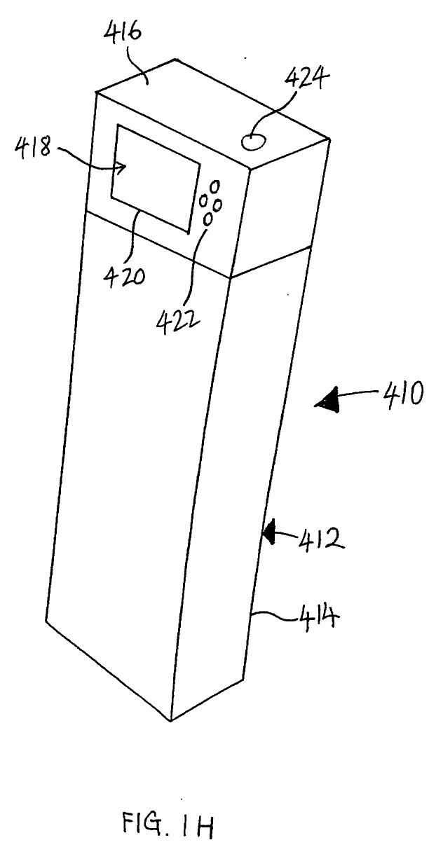

Referring now to the drawings and the characters of reference marked thereon, FIGS. 1A-1E illustrate an embodiment of the present invention, designated generally as 10. The spectacle case 10 includes a housing assembly, designated generally as 12, defining a housing space 17 for storing a pair of spectacles therein. The housing assembly 12, in this embodiment, is an elongated tubular container having a closed lower end 14 and a lid 16 hingedly attached to an upper end thereof. The lid 16 has at least one accessory compartment assembly. In this instance, the lid 16 includes a digital display 18 (e.g., a digital display clock or temperature indicator) and a thermometer 20. A compartment 19 is included in the lid to protect an integrated circuit board. Thus, in terms of space utilization, the housing space 17 includes a spectacle space and a remaining dead space. A spectacle compartment occupies the spectacle space defining an area that is reserved for occupation of a spectacle when the spectacle is received within the housing assembly. The accessory compartments 19, 20 occupy a portion of the dead space of the housing space 17.

In FIGS. 1A-1D the housing assembly 12 has a rectangular cross-section. However, it is understood that various other shapes may be fabricated as desired.

FIGS. 1F and 1G illustrate another embodiment of the present invention, designated generally as 210. The spectacle case 210 includes a housing assembly, designated generally as 212, defining a housing space 217 for storing a pair of spectacles therein. The housing assembly 212 is an elongated tubular container having a closed lower end 214 and a lid 216 hingedly attached to an upper end thereof. The lid 216 has at least one accessory compartment assembly. The lid 216 includes a digital music player 219 and a thermometer 220. The digital music player 219 has a digital display 218, on/off/mode switches 211, a volume/channel switch 213, and an earphone plug-in 215. The digital music player 219 may also include a microphone 217 for digital voice recording. Thus, in terms of space utilization, the housing space 217 includes a spectacle space and a remaining dead space. A spectacle compartment occupies the spectacle space defining an area that is reserved for occupation of a spectacle when the spectacle is received within the housing assembly. The accessory compartments 219, 220 occupy a portion of the dead space of the housing space 217.

In FIGS. 1F and 1G, the housing assembly 212 has a rectangular cross-section. However, it is understood that various other shapes may be fabricated as desired.

FIGS. 1H and 1I illustrate another embodiment of the present invention, designated generally as 410. The spectacle case 410 includes a housing assembly, designated generally as 412, defining a housing space 417 for storing a pair of spectacles therein. The housing assembly 412, in this embodiment, is an elongated tubular container having a closed lower end 414 and a lid 416 hingedly attached to an upper end thereof. The lid 416 has at least one accessory compartment assembly. In this instance, the lid 416 includes a digital camera 418. A compartment 419 is included in the lid to hold the digital camera 418. The digital camera 418 has a display 420, control switches 422, and a shutter button 424. Thus, in terms of space utilization, the housing space 417 includes a spectacle space and a remaining dead space. A spectacle compartment occupies the spectacle space defining an area that is reserved for occupation of a spectacle when the spectacle is received within the housing assembly. The accessory compartment 419 occupies a portion of the dead space of the housing space 417.

In FIGS. 1H and 1I, the housing assembly 412 has a rectangular cross-section. However, it is understood that various other shapes may be fabricated as desired.

Although the digital display, thermometer, digital music player, and digital camera are used to occupy portions of the dead spaces of the housing spaces in FIGS. 1A-1I, it is to be understood that any electrical/electronic device assembly could be used to occupy a portion of the dead space.

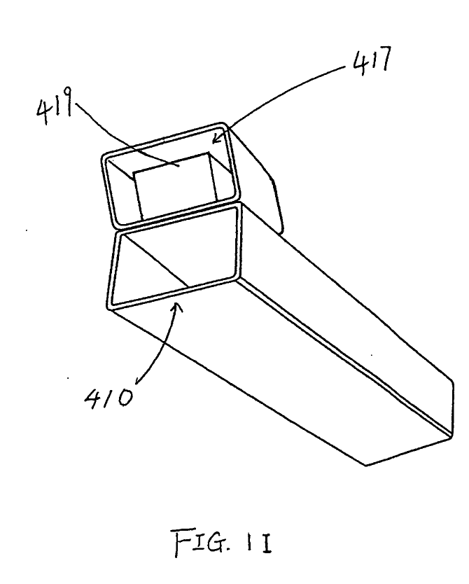

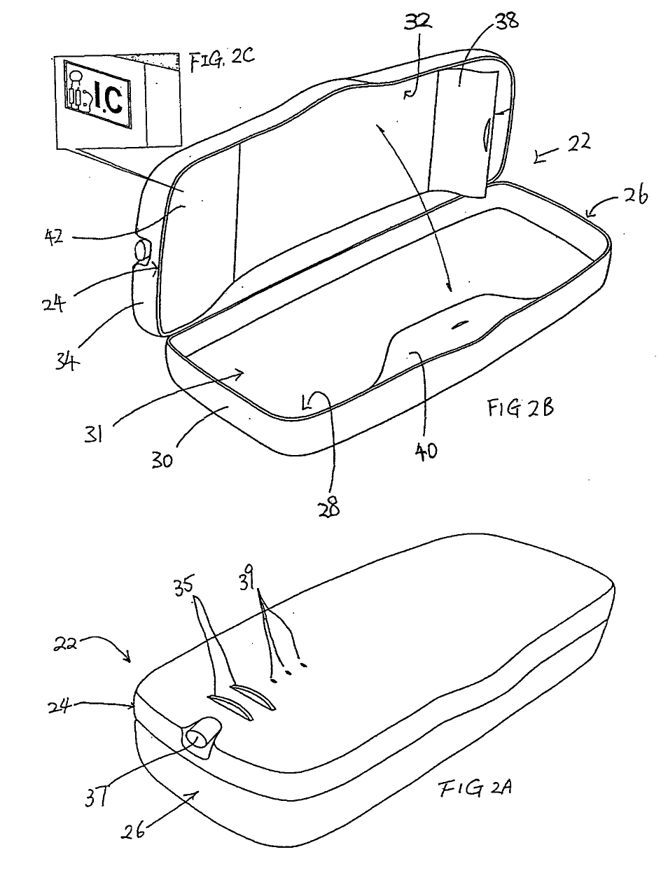

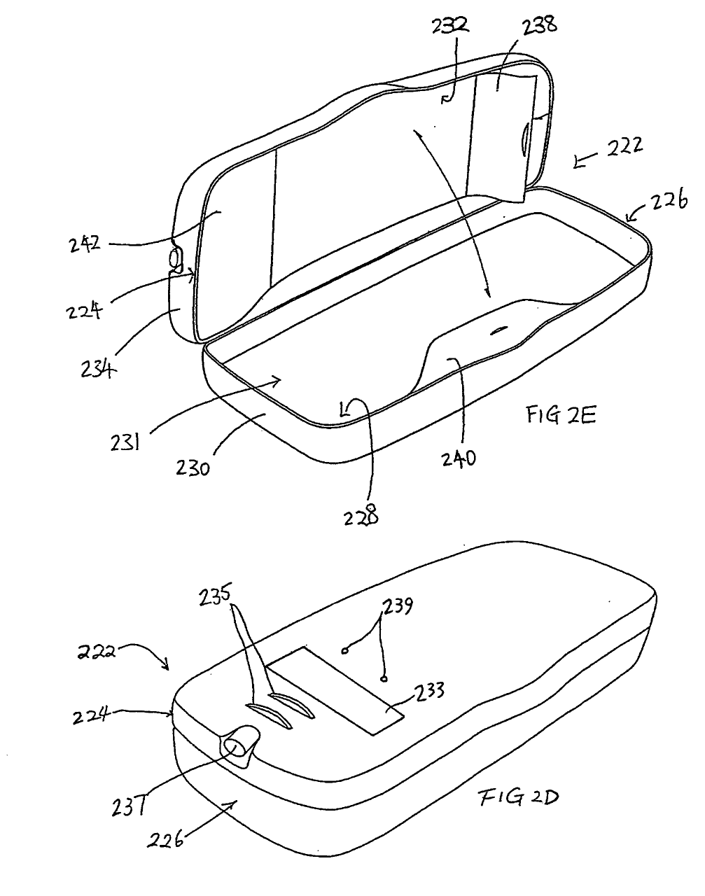

Referring now to FIGS. 2A-2C, another embodiment of the present invention, designated generally as 22, is illustrated. In this embodiment, the housing assembly comprises a clamshell assembly comprising an upper clamshell section 24 hingedly attached to a lower clamshell section 26. The housing assembly defines a housing space 31 for storing a pair of spectacles therein. The housing space 31 includes a spectacle space and a remaining dead space. The lower clamshell section 26 includes a base 28 and substantially perpendicular lower sidewalls 30 extending from the base 28. The upper clamshell section 24 comprises a ceiling 32 and substantially perpendicular upper sidewalls 34 extending from the ceiling 32.

An accessory compartment assembly includes a radio assembly having controls 35 (such as a volume switch and channel switch), an antenna 37, and indicator lights 39. An accessory compartment separation element 38 is operatively associated with the ceiling to separate the spectacle space from the dead space. The accessory compartment separation element 38 may comprise a flap, as shown in the figure, or other suitable separation elements such as a door or panel. Another accessory compartment may be a battery compartment 40 for the radio assembly which may be conveniently located in a volume formed within the lower clamshell section 26. Another accessory compartment 42 on the other end of the upper clamshell section 24 may be used to support the integrated circuit of the radio assembly or other small accessories as desired. The radio assembly and the compartments 40 and 42 occupy a portion of the dead space of the housing space 31.

FIGS. 2D and 2E show another embodiment of the present invention, designated generally as 222. In this embodiment, the housing assembly comprises a clamshell assembly comprising an upper clamshell section 224 hingedly attached to a lower clamshell section 226. The housing assembly defines a housing space 231 for storing a pair of spectacles therein. The housing space 231 includes a spectacle space and a remaining dead space. The lower clamshell section 226 includes a base 228 and substantially perpendicular lower sidewalls 230 extending from the base 228. The upper clamshell section 224 comprises a ceiling 232 and substantially perpendicular upper sidewalls 234 extending from the ceiling 232.

An accessory compartment assembly includes a digital music player assembly having a display 233, controls 235 (such as a volume switch and channel switch), an antenna 237, and on/off/mode switches 239. An accessory compartment separation element 238 is operatively associated with the ceiling to separate the spectacle space from the dead space. The accessory compartment separation element 238 may comprise a flap, as shown in the figure, or other suitable separation elements such as a door or panel. Another accessory compartment may be a battery compartment 240 for the digital music player assembly which may be conveniently located in a volume formed within the lower clamshell section 226. Another accessory compartment 242 on the other end of the upper clamshell section 224 may be used to support the integrated circuit and hard disk of the digital music player or other small accessories as desired. The digital music player assembly and the compartments 240 and 242 occupy a portion of the dead space of the housing space 231.

Although the radio assembly, digital music player assembly, and accessory compartments are used to occupy portions of the dead spaces of the housing spaces in FIGS. 2A-2E, it is to be understood that any electrical/electronic device assembly could be used to occupy a portion of the dead space.

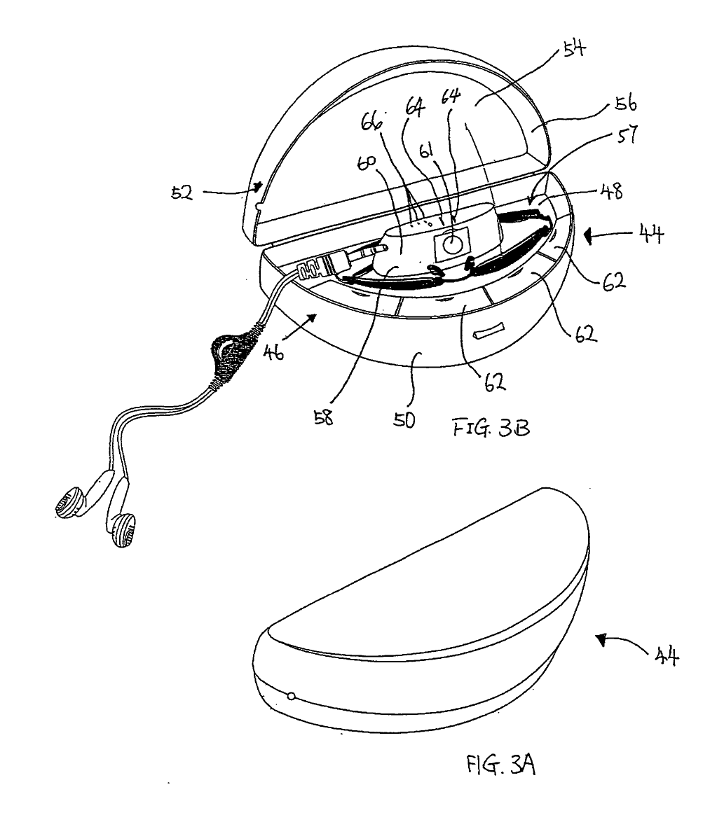

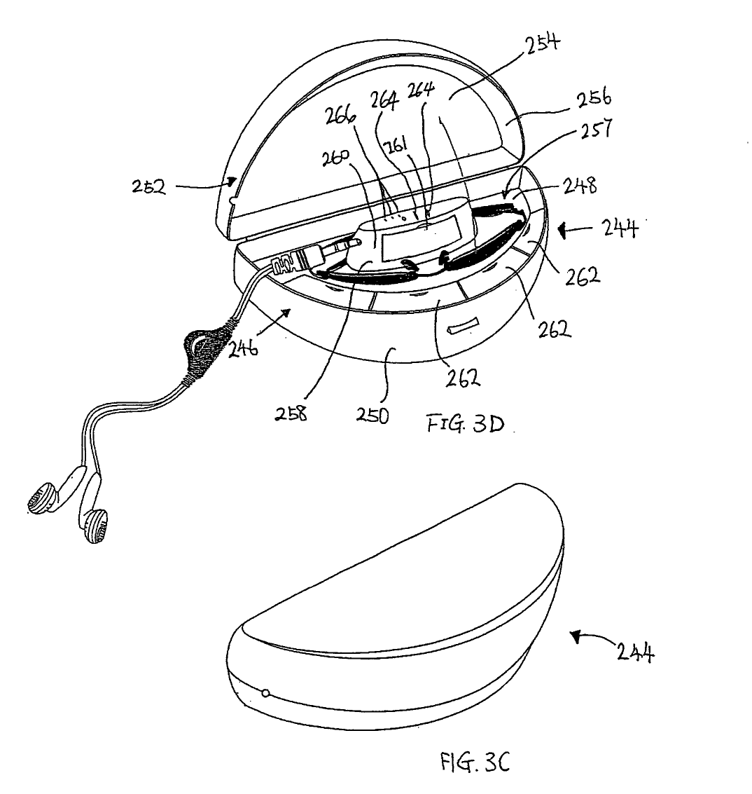

Referring now to FIGS. 3A and 3B, another embodiment of the present invention is illustrated, designated generally as 44. The housing assembly defines a housing space 57 for storing a pair of spectacles therein. The housing space 57 includes a spectacle space and a remaining dead space. In this embodiment, a lower clamshell section, designated generally as 46 comprises an arc-shaped base 48 and substantially perpendicular lower sidewalls 50 extending from the base 48. An upper clamshell section, designated generally as 52, comprises a ceiling 54 and substantially perpendicular upper sidewalls 56 extending from the ceiling 54.

In this embodiment, the accessory compartment assembly includes a radio assembly 58 utilizing an accessory compartment separation element 60 that is operatively associated with the base 48. A battery compartment 61 can be included in the accessory compartment separation element 60. The radio assembly 58 and the battery compartment 61 generally occupy a portion of the dead space of the housing space 57. A plurality of arcuately spaced accessory compartments 62 are located about an internal surface of the lower sidewalls 50 of the arc-shaped base 48 to occupy a portion of the dead space of the housing space 57. Appropriate switches 64 and indicator lights 66 may be provided on the top surfaces of the radio assembly 58.

In FIGS. 3C and 3D, another embodiment of the present invention is illustrated, designated generally as 244. The housing assembly defines a housing space 257 for storing a pair of spectacles therein. The housing space 257 includes a spectacle space and a remaining dead space. In this embodiment, a lower clamshell section, designated generally as 246 comprises an arc-shaped base 248 and substantially perpendicular lower sidewalls 250 extending from the base 248. An upper clamshell section, designated generally as 252, comprises a ceiling 254 and substantially perpendicular upper sidewalls 256 extending from the ceiling 254.

In this embodiment the accessory compartment assembly includes a digital music player assembly 258 utilizing an accessory compartment separation element 260 that is operatively associated with the base 248. The digital music player assembly 258 generally occupies a portion of the dead space of the housing space 257. A plurality of arcuately spaced accessory compartments 262 are located about an internal surface of the lower sidewalls 250 of the arc-shaped base 248 to occupy a portion of the dead space of the housing space 257. Display 261, volume/channel switches 264, and on/off/mode switches 266 are provided on the digital music player assembly 258.

Although the radio assembly, digital music player assembly, and accessory compartments are used to occupy portions of the dead spaces of the housing spaces in FIGS. 3A-3D, it is to be understood that any electrical/electronic device assembly could be used to occupy a portion of the dead space.

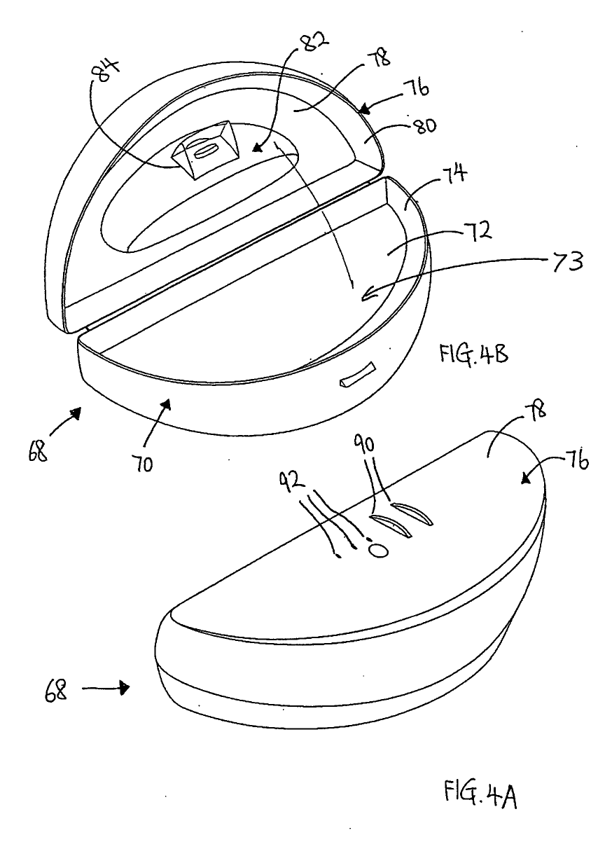

Referring now to FIGS. 4A and 4B, another embodiment of the present invention is illustrated, designated generally as 68. The housing assembly defines a housing space 73 for storing a pair of spectacles therein. The housing space 73 includes a spectacle space and a remaining dead space. As in the previous embodiment, a lower clamshell section, designated generally as 70 comprises an arc-shaped base 72 and substantially perpendicular lower sidewalls 74 extending from the base 72. An upper clamshell section, designated generally as 76, comprises a ceiling 78 and substantially perpendicular upper sidewalls 80 extending from the ceiling 78.

In this embodiment, the accessory compartment assembly includes a radio assembly 82 utilizing an accessory compartment separation element 84 that is operatively associated with the ceiling 78 such that the radio assembly 82 is affixed to the ceiling 78. A battery compartment can be included in the accessory compartment separation element 84. The radio assembly 82 and the battery compartment occupy a portion of the dead space of the housing space 73. As shown in FIG. 4A, appropriate switches 90 and indicator lights 92 may be provided on the upper clamshell section 76.

Although the radio assembly is used to occupy a portion of the dead space of the housing space in FIGS. 4A-4B, it is to be understood that any electrical/electronic device assembly could be used to occupy a portion of the dead space.

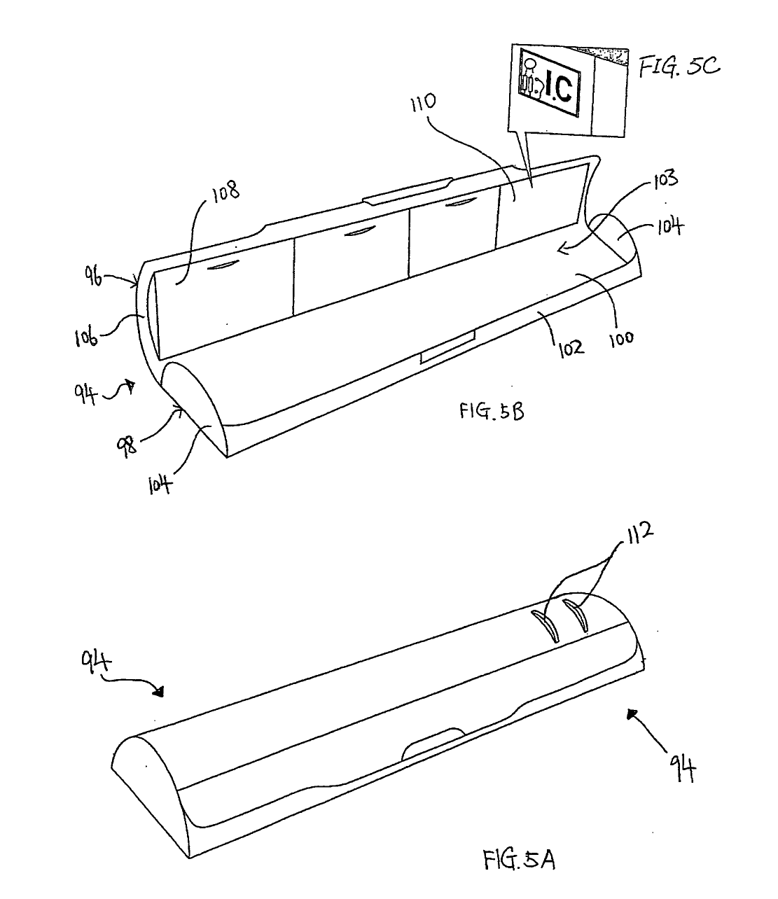

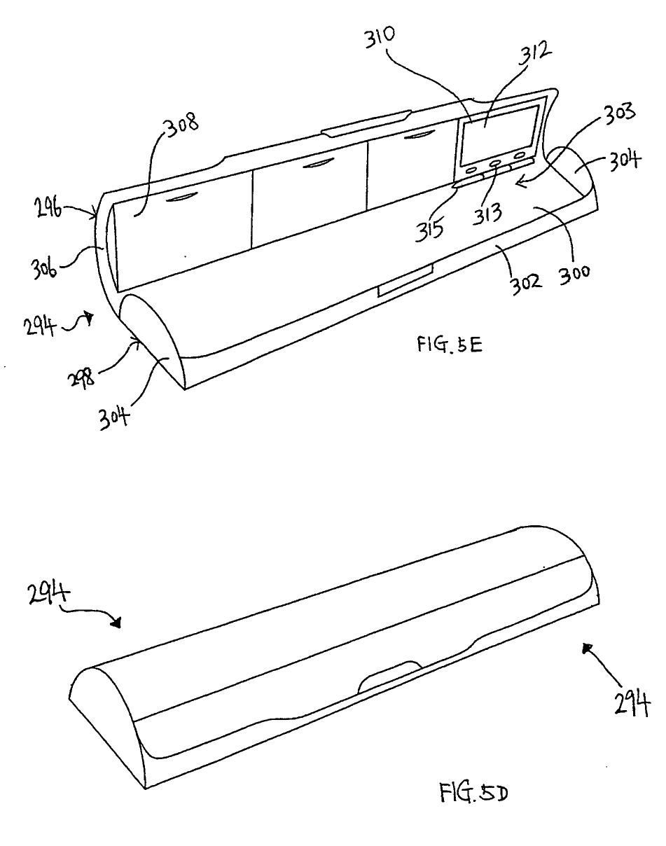

Referring now to FIGS. 5A-5C, another embodiment of the present invention is illustrated, designated generally as 94. The housing assembly defines a housing space 103 for storing a pair of spectacles therein. The housing space 103 includes a spectacle space and a remaining dead space. In this embodiment, the housing assembly comprises a clamshell assembly having an arching upper clamshell section 96 hingedly attached to a lower clamshell section 98. The lower clamshell section 98 comprises a base 100, a lower clamshell section front panel 102 extending upwardly from the base 100 and two arc shaped lower clamshell side panels 104 extending upwardly from the base 100. The arching upper clamshell section 96 includes two arc shaped upper clamshell side panels 106 being sized to cooperate with the two arc shaped lower clamshell side panels 104.

A series of spaced accessory compartments are formed by a plurality of accessory compartment separation elements 108. The accessory compartment separation elements 108 are each attached to a rear portion of the arching upper clamshell section so as to open at a front portion of the upper clamshell section 96. One of the spaced accessory compartments is a radio assembly 110 including control knobs 112 and earphone plug-in (not shown). The spaced accessory compartments occupy a portion of the dead space of the housing space 103. The base 100 may be substantially rectangular to particularly accommodate a pair of reading glasses.

FIGS. 5D and 5E show another embodiment of the present invention, designated generally as 294. The housing assembly defines a housing space 303 for storing a pair of spectacles therein. The housing space 303 includes a spectacle space and a remaining dead space. In this embodiment, the housing assembly comprises a clamshell assembly having an arching upper clamshell section 296 hingedly attached to a lower clamshell section 298. The lower clamshell section 298 comprises a base 300, a lower clamshell section front panel 302 extending upwardly from the base 300 and two arc shaped lower clamshell side panels 304 extending upwardly from the base 300. The arching upper clamshell section 296 includes two arc shaped upper clamshell side panels 306 being sized to cooperate with the two arc shaped lower clamshell side panels 304.

A series of spaced accessory compartments are formed by a plurality of accessory compartment separation elements 308. The accessory compartment separation elements 308 are each attached to a rear portion of the arching upper clamshell section so as to open at a front portion of the upper clamshell section 296. One of the spaced accessory compartments is a personal digital assistant (PDA) assembly 310 including a display 312, a plurality of keys 313, and a stylus 315. The spaced accessory compartments occupy a portion of the dead space of the housing space 03. The spaced accessory compartments may be used to hold the stylus 315, memory cards, etc. The base 300 may be substantially rectangular to particularly accommodate a pair of reading glasses.

Although the radio assembly, personal digital assistant (PDA) and accessory compartments are used to occupy portions of the dead spaces of the housing spaces in FIGS. 5A-5E, it is to be understood that any electrical/electronic device assembly could be used to occupy a portion of the dead space.

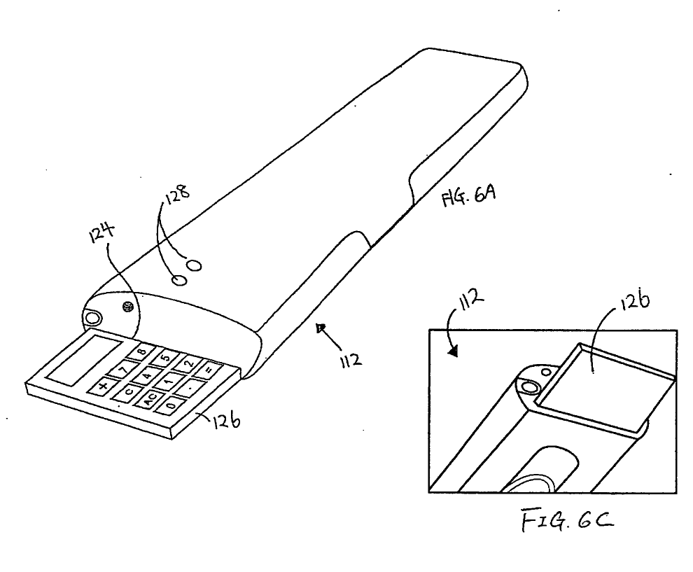

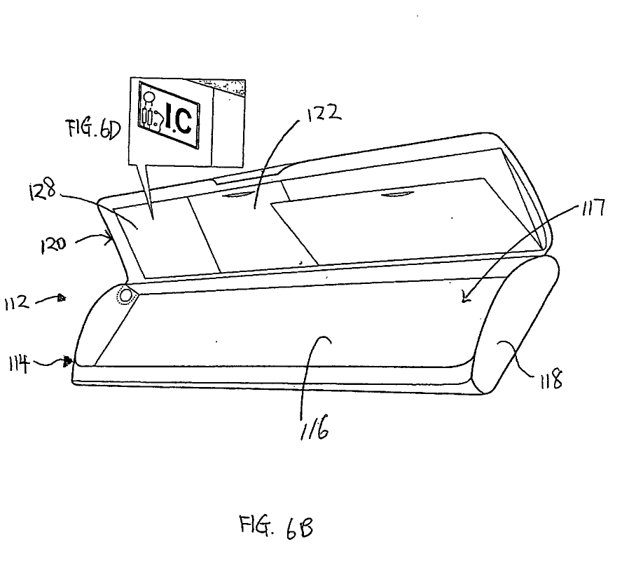

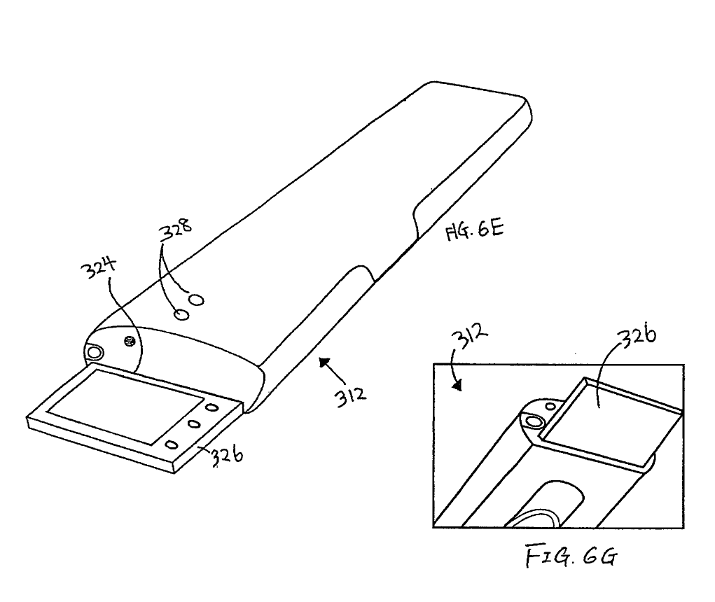

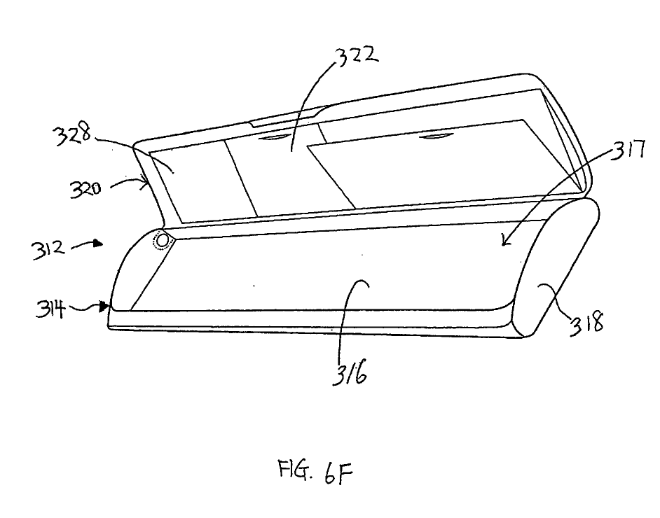

Referring now to FIGS. 6A-6D, another embodiment of the present invention, designated generally as 112, is illustrated. The housing assembly defines a housing space 117 for storing a pair of spectacles therein. The housing space 117 includes a spectacle space and a remaining dead space. In this embodiment, a lower clamshell section 114 comprises a base 116 and substantially perpendicular lower sidewalls 118 extending from the base 116.

An upper clamshell section 120 comprises a ceiling 122 which operatively associates with the lower clamshell section 114 to provide a closed structure when the housing assembly is closed. The accessory compartment assembly includes a calculator assembly having a calculator opening 124 provided in one of the clamshell sections and a calculator 126 being sized for convenient storage within the calculator opening 124. It also includes a radio assembly 128 affixed to the ceiling 122. The accessory compartment assembly occupies a portion of the dead space of the housing space 117.

FIGS. 6E-6F show another embodiment of the present invention, designated generally as 312. The housing assembly defines a housing space 317 for storing a pair of spectacles therein. The housing space 317 includes a spectacle space and a remaining dead space. In this embodiment, a lower clamshell section 314 comprises a base 316 and substantially perpendicular lower sidewalls 318 extending from the base 316.

An upper clamshell section 320 comprises a ceiling 322 which operatively associates with the lower clamshell section 314 to provide a closed structure when the housing assembly is closed. The accessory compartment assembly includes a personal digital assistant (PDA) assembly having an opening 324 provided in one of the clamshell sections and a personal digital assistant 326 being sized for convenient storage within the opening 324. It also includes a digital music player assembly 328 affixed to the ceiling 322. The accessory compartment assembly occupies a portion of the dead space of the housing space 317. The accessory compartments may be used for holding a stylus, an earphone, memory cards, etc.

Although the calculator, radio assembly, personal digital assistant (PDA) assembly, digital music player assembly, and accessory compartments are used to occupy portions of the dead spaces of the housing spaces in FIGS. 6A-6F, it is to be understood that any electrical/electronic device assembly could be used to occupy a portion of the dead space.

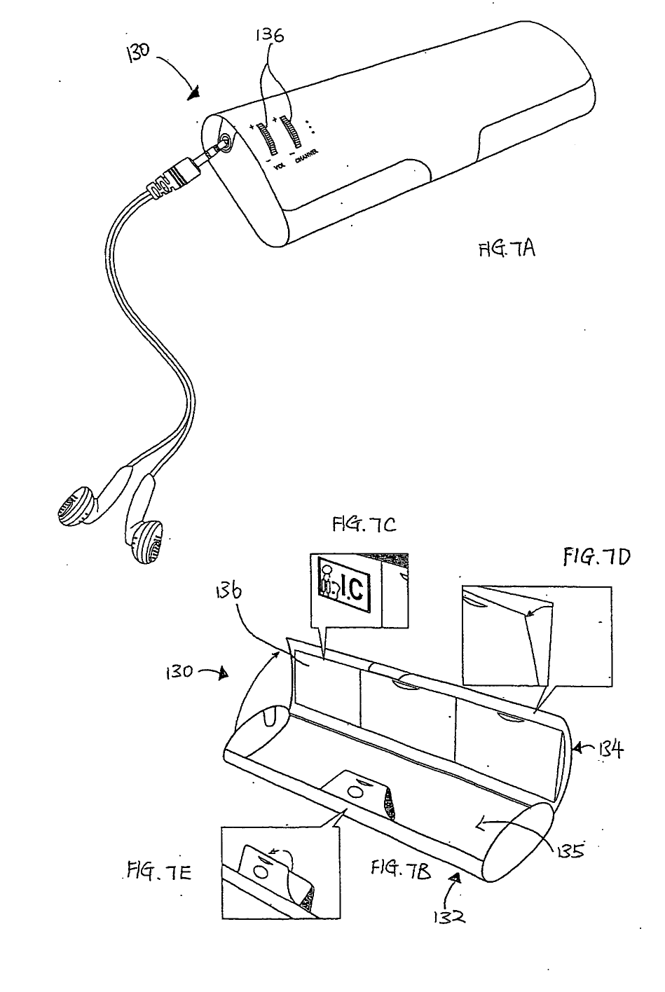

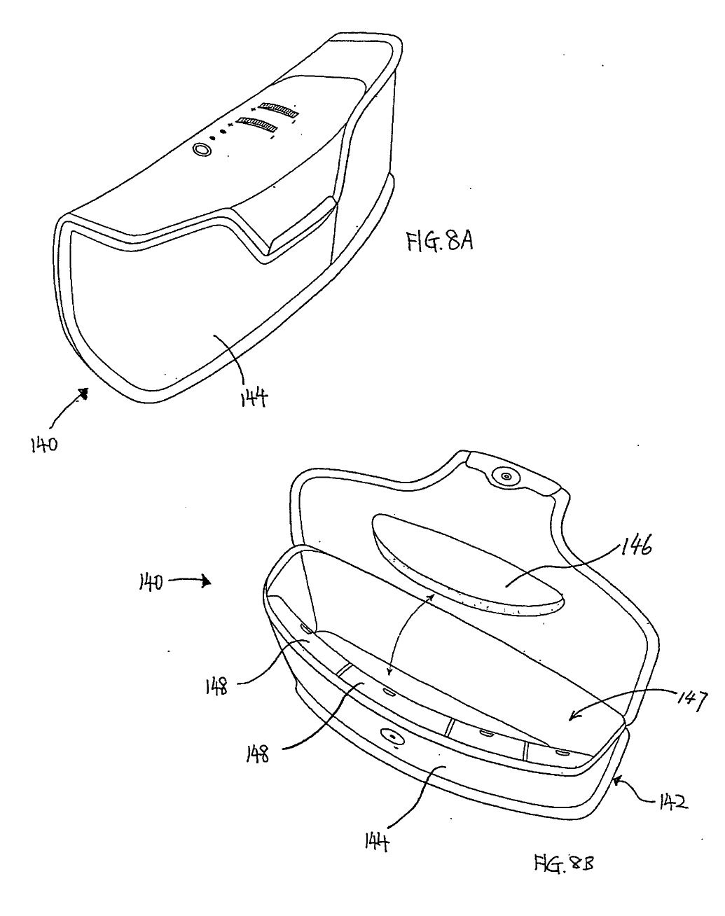

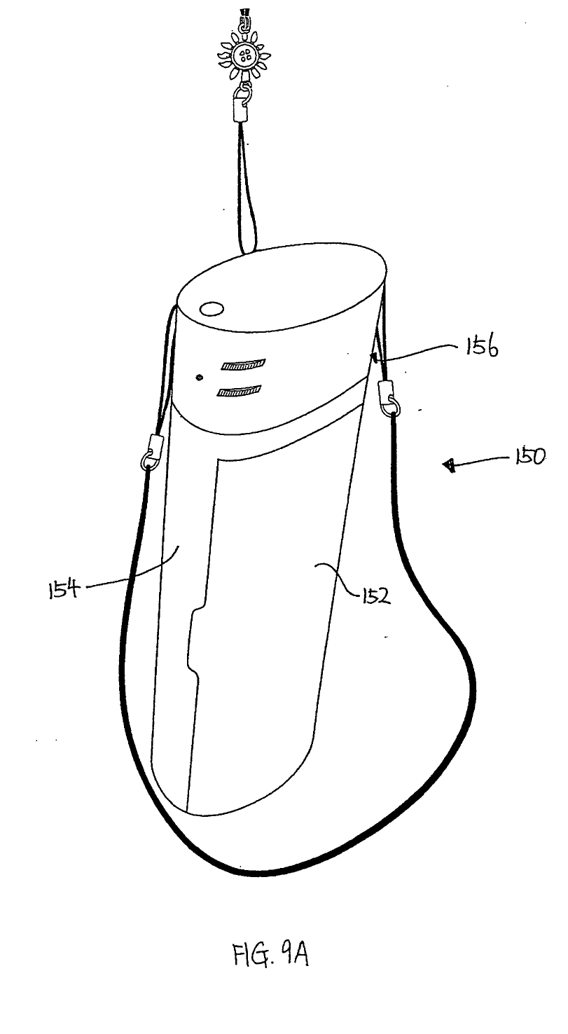

Referring now to FIGS. 7A-7E, another embodiment, designated generally as 130, is illustrated. The housing assembly defines a housing space 135 for storing a pair of spectacles therein. The housing space 135 includes a spectacle space and a remaining dead space. In this embodiment, a lower clamshell section 132 and upper clamshell section 134 cooperate to provide a clamshell assembly having an oval cross-sectional area. A radio assembly 136 is operatively associated with the ceiling of the upper clamshell section 134 so as to affix the radio assembly 136 to the ceiling. FIG. 7C schematically illustrates the positioning of an integrated circuit in one of the accessory compartments. FIG. 7D is a section of FIG. 7B showing how an accessory compartment on the lid is opened. FIG. 7E is a section of FIG. 7B showing how another accessory compartment located in the side of the case base is opened. The radio assembly 136 and the accessory compartments occupy a portion of the dead space of the housing space 135.

Although the radio assembly and accessory compartments are used to occupy a portion of the dead space of the housing space in FIGS. 7A-7E, it is to be understood that any electrical/electronic device assembly could be used to occupy a portion of the dead space.

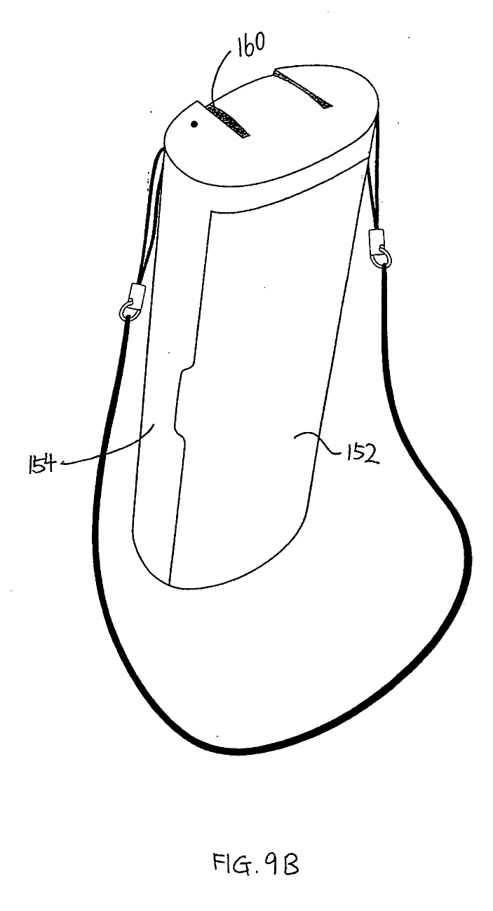

Referring now to FIGS. 8A and 8B, another embodiment of the present invention, designated generally as 140, is illustrated. The housing assembly defines a housing space 147 for storing a pair of spectacles therein. The housing space 147 includes a spectacle space and a remaining dead space. In this embodiment, the lower clamshell section 142 comprises an arc-shaped base and substantially perpendicular lower sidewalls 144 extending from the base. This embodiment includes a radio assembly 146 operatively associated with the ceiling. In the illustrated embodiment, the radio assembly 146 has a disc shape. The radio assembly 146 may include a battery compartment. The radio assembly 146 generally occupies a portion of the dead space of the housing space 147 of the spectacle case 140. A plurality of arcuately spaced accessory compartments 148 are located about an internal surface of the lower sidewalls 144 of the arc-shaped base. The accessory compartments 148 generally occupy a portion of the dead space of the housing space 147 of the spectacle case 140.

Although the radio assembly and accessory compartments are used to occupy a portion of the dead space of the housing space in FIGS. 8A and 8B, it is to be understood that any electrical/electronic device assembly could be used to occupy a portion of the dead space.

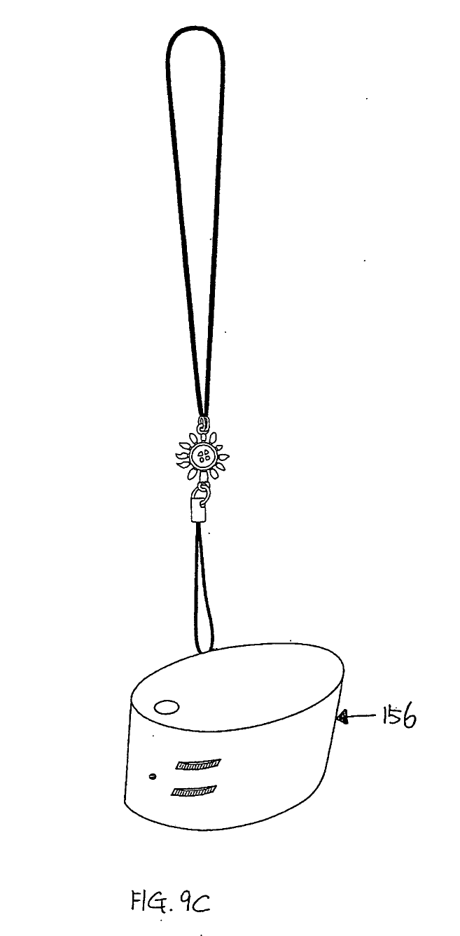

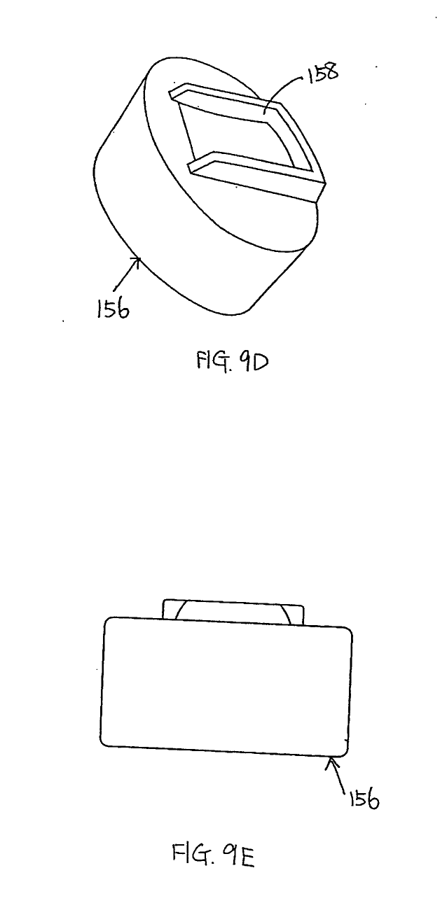

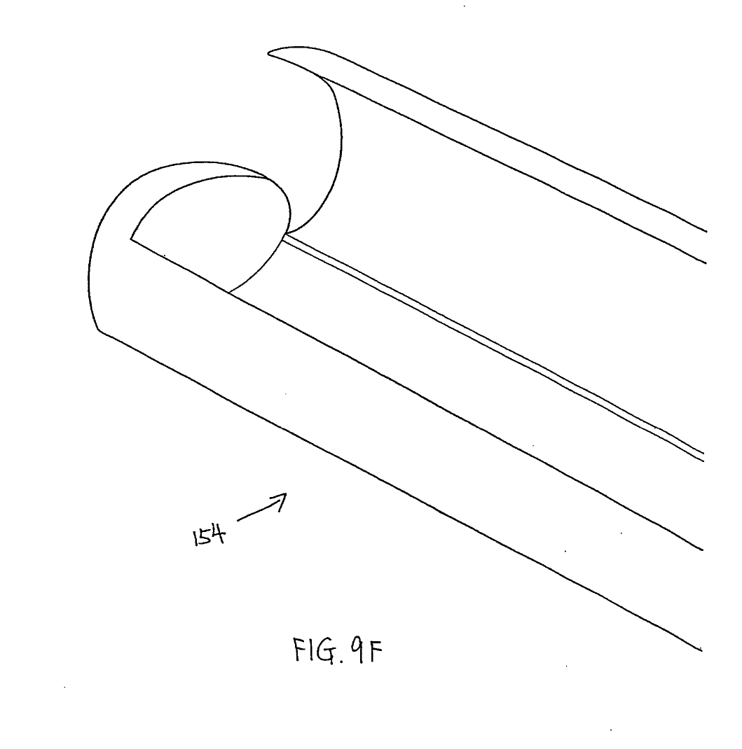

Referring now to FIGS. 9A-9F, another embodiment, designated generally as 150, is illustrated. In this embodiment, the housing assembly includes a clamshell assembly comprising an upper clamshell section 152 hingedly attached to a lower clamshell section 154. The lower clamshell section comprises a base and sidewalls extending from the base. In the embodiment shown the base and sidewalls are contiguous so that there is approximately an oval cross-section. The upper clamshell section 152 comprises a ceiling which operatively associates with the lower clamshell section 154 to provide a closed structure when the housing assembly is closed.

A detachable accessory compartment assembly, such as a radio assembly, designated generally as 156, may be removed from the clamshell assembly. Although various fastening mechanisms can be utilized these Figures show use of a slideable bracket 158 and slot 160. The removable attachment configuration provides advantages. For example, the user can carry either the clamshell assembly or the radio assembly. The user can also carry the combination of the clamshell assembly and the radio assembly when needed.

Although the radio assembly is used to occupy a portion of the dead space of the housing space in FIGS. 8A and 8B, it is to be understood that any electrical/electronic device assembly could be used to occupy a portion of the dead space.

Although specific embodiments have been described above the inventive principles herein can be used to provide numerous combinations, such as a combination of spectacle case and radio, combination of spectacle case and thermometer, combination of spectacle case and calculator, combination of spectacle case and electrical/electronic device assembly, etc.

Other embodiments and configurations may be devised without departing from the spirit of the invention and the scope of the appended claims.

1. A spectacle case, comprising:
a) a housing assembly defining a housing space for storing a pair of spectacles therein, said housing space comprising a spectacle space and a remaining dead space;
b) a spectacle compartment occupying said spectacle space defining an area that is reserved for occupation of said spectacle when said spectacle is received within said housing assembly; and
c) at least one accessory compartment assembly occupying at least a portion of said dead space, said at least one accessory compartment assembly including at least one accessory compartment separation element for providing a desired separation of said spectacle compartment and said at least one accessory compartment assembly.

2. The spectacle case of claim 1, wherein said at least one accessory compartment assembly comprises an electrical/electronic device assembly.

3. The spectacle case of claim 1, wherein said housing assembly comprises an elongated tubular container.

4. The spectacle case of claim 1, wherein said housing assembly comprises an elongated tubular container having a closed lower end and a lid hingedly attached to an upper end thereof, said lid comprising said at least one accessory compartment assembly.

5. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell comprising a ceiling and substantially perpendicular upper sidewalls extending from said ceiling.

6. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said accessory compartment separation element operatively associated with said ceiling.

7. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said accessory compartment separation element operatively associated with said ceiling to separate said spectacle space from said dead space, said accessory compartment separation element comprising a flap.

8. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said accessory compartment separation element operatively associated with said base.

9. The spectacle case of claim 1, wherein said housing assembly comprises a clamshell assembly comprising an upper clamshell section hingedly attached to a lower clamshell section,
said lower clamshell section comprising an arc-shaped base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said at least one accessory compartment separation element operatively associated with said base; and
a plurality of arcuately spaced accessory compartments located about an internal surface of said lower sidewalls of said arc-shaped base.

10. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said accessory compartment separation element operatively associated with said ceiling so as to affix said electrical/electronic device assembly to said ceiling.

11. The spectacle case of claim 1, wherein said housing assembly comprises a clamshell assembly comprising an arching upper clamshell section hingedly attached to a lower clamshell section,
said lower clamshell section comprising a base, a lower clamshell section front panel extending upwardly from said base and two arc shaped lower clamshell side panels extending upwardly from said base,
said arching upper clamshell section including two arc shaped upper clamshell side panels being sized to cooperate with said two arc shaped lower clamshell side panels,
said at least one accessory compartment assembly comprising a series of spaced compartments formed by a plurality of said accessory compartment separation elements, said accessory compartment separation elements each being fixedly attached to a rear portion of said arching upper clamshell section so as to open at a front portion of said upper clamshell section.

12. The spectacle case of claim 1, wherein said housing assembly comprises a clamshell assembly comprising an arching upper clamshell section hingedly attached to a lower clamshell section,
said lower clamshell section comprising a base, a lower clamshell section front panel extending upwardly from said base and two arc shaped lower clamshell side panels extending upwardly from said base,
said arching upper clamshell section including two arc shaped upper clamshell side panels being sized to cooperate with said two arc shaped lower clamshell side panels,
said at least one accessory compartment assembly comprising a series of spaced accessory compartments formed by a plurality of said accessory compartment separation elements, said accessory compartment separation elements each being fixedly attached to a rear portion of said arching upper clamshell section so as to open at a front portion of said upper clamshell section,
one of said spaced accessory compartments comprising an electrical/electronic device assembly.

13. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling which operatively associates with said lower clamshell section to provide a closed structure when the housing assembly is closed,
one of said clamshell sections having an opening,
said at least one accessory compartment assembly, comprising:
an electrical/electronic device assembly being sized for convenient storage within said opening.

14. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling which operatively associates with said lower clamshell section to provide a closed structure when the housing assembly is closed,
one of said clamshell sections having an opening,
said at least one accessory compartment assembly, comprising:
a first electrical/electronic device assembly being sized for convenient storage within said opening; and
a second electrical/electronic device assembly, said accessory compartment separation element operatively associated with said ceiling so as to affix said second electrical/electronic device assembly to said ceiling.

15. The spectacle case of claim 1, wherein said housing assembly comprises a clamshell assembly comprising an upper clamshell section hingedly attached to a lower clamshell section,
said lower clamshell section comprising a base and substantially perpendicular lower sidewalls extending from said base,
said upper clamshell section comprising a ceiling which operatively associates with
said lower clamshell section to provide a closed structure when the housing assembly is closed, said lower clamshell section and said upper clamshell section cooperating to provide a clamshell assembly having an oval cross-sectional area,
said at least one accessory compartment assembly, comprising:
an electrical/electronic device assembly, said accessory compartment separation element operatively associated with said ceiling so as to affix said electrical/electronic device assembly to said ceiling.

16. The spectacle case of claim 1, wherein said housing assembly comprises a clamshell assembly comprising an upper clamshell section attached to a lower clamshell section,
said lower clamshell section comprising an arc-shaped base and substantially perpendicular lower sidewalls extending from said base,
said upper clamshell section comprising a ceiling and substantially perpendicular upper sidewalls extending from said ceiling,
said at least one accessory compartment assembly, comprising:
an electrical/electronic device assembly, said at least one accessory compartment separation element operatively associated with said ceiling; and
a plurality of arcuately spaced accessory compartments located about an internal surface of said lower sidewalls of said arc-shaped base.

17. The spectacle case of claim 1, wherein said housing assembly comprises:
a clamshell assembly comprising an upper clamshell section hingedly attached to a lower clamshell section,
said lower clamshell section comprising a base and sidewalls extending from said base,
said upper clamshell section comprising a ceiling which operatively associates with said lower clamshell section to provide a closed structure when the housing assembly is closed; and
wherein said at least one accessory compartment assembly includes a detachable accessory compartment assembly, and said detachable accessory compartment assembly is detachable from an end of said clamshell assembly.

18. The spectacle case of claim 1, wherein said housing assembly comprises:
a clamshell assembly comprising an upper clamshell section hingedly attached to a lower clamshell section,
said lower clamshell section comprising a base and sidewalls extending from said base,
said upper clamshell section comprising a ceiling which operatively associates with said lower clamshell section to provide a closed structure when the housing assembly is closed; and
wherein said at least one accessory compartment assembly includes a detachable accessory compartment assembly, and said detachable accessory compartment assembly is detachable from an end of said clamshell assembly and includes a bracket assembly.

19. The spectacle case of claim 1, wherein said housing assembly comprises:
a clamshell assembly comprising an upper clamshell section hingedly attached to a lower clamshell section,
said lower clamshell section comprising a base and sidewalls extending from said base,
said upper clamshell section comprising a ceiling which operatively associates with said lower clamshell section to provide a closed structure when the housing assembly is closed; and
wherein said at least one accessory compartment assembly is a detachable accessory compartment assembly, and said detachable accessory compartment assembly is detachable from an end of said clamshell assembly and includes an electrical/electronic device assembly.

20. A spectacle case, comprising:
a) a housing assembly defining a housing space for storing a pair of spectacles therein, said housing space comprising a spectacle space and a remaining dead space;
b) a spectacle compartment occupying said spectacle space defining an area that is reserved for occupation of said spectacle when said spectacle is received within said housing assembly; and
c) an electrical/electronic device assembly occupying at least a portion of said dead space.
